(19) United States
(12) Patent Application Publication
(10) Pub. No.: US 2009/0218490 A1
(43) Pub. Date: Sep. 3, 2009

(54) APPARATUS AND METHOD OF SEMICONDUCTOR DEFECT INSPECTION

(75) Inventors: Shinichi SUZUKI, Ome (JP); Kaoru Umemura, Tokyo (JP); Daiji Fujiwara, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/369,405

(22) Filed: Feb. 11, 2009

(30) Foreign Application Priority Data
Feb. 28, 2008 (JP) 2008-047028

(51) Int. Cl. G01N 23/00

(52) U.S. Cl. 250/307; 250/310

(57) ABSTRACT

An object of the present invention is to provide an apparatus and a method of semiconductor defect inspection in which an optimal process condition can be determined without performing electrical evaluation. To achieve the object, the present invention includes a configuration in which the type of an extracted defect is identified with reference to a database that stores the types of defects obtained by inspecting a sample, a defect density according to each defect type is obtained for each region of the sample, and the defect density is displayed. Moreover, the present invention includes a configuration in which the type of an extracted defect is identified with reference to a database that stores the types of defects obtained by inspecting a sample, a defect density according to each defect type is determined for each production process of the sample, and the defect density is displayed on a display.

### BACKGROUND OF THE INVENTION

1. Field of the Invention

The present invention relates to an apparatus and a method of semiconductor defect inspection for inspecting a defect in a semiconductor integrated circuit production process.

2. Description of the Related Art

There has been a demand for improvement in current density and reduction of interconnect capacitance in semiconductor integrated circuits in accordance with a tendency toward high integration of interconnects and high performance of the semiconductor integrated circuit. For this reason, in a back end of line (BEOL) to form interconnects of the semiconductor integrated circuit in a wafer, a manufacturing technique using new materials such as Cu dual damascene, organic spin coat films, and inorganic Low-k films having a reduced dielectric constant (low dielectric insulating films) has been progressed. On the other hand, main defects generated in the production process using these new materials include voids in a Cu interconnect layer or a Low-k film, and not-opened parts (for example, etch-stop) in which the interconnects are formed only halfway. In an electroplating process to form Cu interconnects, formation and inclusion of voids are inescapable. A void defect due to stress called stress induced voiding (SIV) is also generated. In a spin coat Low-k film formation process, types of the voids range from large voids having a large critical level to pores of several nano meters that affect the dielectric constant. These voids affect electrical characteristics, such as breakdown voltage of an inter layer dielectric (ILD) and capacitance. A defect of etch-stop is caused due to instability of local plasma in an etching process or instability in a photolithography process. This is a critical defect although occurrence frequency is low. Moreover, in a front end of line (FEOL) that is a transistor formation process, new materials and techniques are being introduced as countermeasures against increase of leakage current caused by reduction of gate length of polycrystalline silicon gates. For example, a metal gate process using NixSil-x, TiN or the like instead of polycrystalline silicon, a high-k process using Hf compound high dielectric film materials or the like instead of an oxide film are included. These production processes have problems, such as abnormal growth of a metal on a silicon substrate, or metal short on an insulating film. Conventionally, work of efficiently inspecting a lot of types of defects as described above in the production process and thereby identifying the defect has been very difficult.

When determining a production process or a production condition in a semiconductor integrated circuit product development stage, a scanning electron microscope (SEM), a transmission electron microscope (TEM), and a scanning transmission electron microscope (STEM) are often used in order to observe a cross section of the semiconductor integrated circuit. However, since these apparatuses have a small spot size of an electron beam with which the apparatuses irradiate a sample, their inspection speed is slow. Therefore, the number of points to be observed is limited, and it is difficult to obtain defect distribution or the like in the wafer, in which the semiconductor integrated circuit is formed, at an early stage. Moreover, when the position of a hot spot, which is a region where structurally the defect tends to be generated, is unknown, probe evaluation of the hot spot in mass production is difficult. In particular, it is not easy to find internal defects attributed to lack of a margin in superposition of photoresist patterns formed of three layers such as an isolation layer, a gate electrode layer, and a contact layer. Additionally, at a mass production stage, quality control (QC) aiming at preventing generation of a huge number of defects is performed in a general production line. As QC for prevention of generation of defects attributed to a fluctuation factor of performance of a manufacturing apparatus, apparatus QC for each apparatus is performed by focusing on, for example, foreign substances, thickness of a film, quality of a film, etc. However, it is impossible to detect defects not only attributed to one apparatus but also caused in combination of performance fluctuations of several apparatuses, by the apparatus QC for each apparatus. Although a technique that can detect such defects is introduced in electric probe evaluation, turn around time (TAT) is long and reaches several weeks at the longest. Accordingly, it takes some time to investigate causes of the defects generated when a large number of defects occur, so that start of countermeasures is delayed.

In the present condition of the above-mentioned QC in the production process, in many cases, wafer inspection and circuit tester inspection using an electric probe are conducted after circuit pattern formation to evaluate series connection probe and to then decide whether to meet a mass production standard. However, with this method, when the production process has long steps, it is difficult to attain quick turn around time (QTAT), and feedback to a step responsible for generation of the defect is insufficient. Furthermore, when, in order to measure the electrical characteristics of a product having gone through the responsible step, a few more subsequent steps are needed to finish the product as a final product after the responsible step, it is difficult to tell that the subsequent steps are irresponsible for generation of the defect, and also difficult to measure the true electrical characteristics in the responsible step.

In the case of the above-mentioned defective interconnects, inspection is performed using a voltage contrast image (VC image), which is obtained by irradiating a sample such as a wafer with an electron beam by use of an electron microscope, charging the sample, and irradiating the sample with the electron beam again in this charged state (see, for example, Japanese Patent Application Publication No. JP2002-009121A). This technique uses temporal change of the charging state on the sample. A position of the defect is determined on the basis of a visual difference between an image of a defective part and an image of a normal part. However, this technique is only for finding out whether the defect is defective continuity or short circuit failure, and the type of the defect cannot be found out.

If defects affecting a yield can be classified and detected in the course of the production process, the type of the defect can be found out, and the cause of generation of the defect can thereby be investigated, feedback of an inspection result can be performed in the course of the production process, so that reliability and a yield of the final product can be improved. Furthermore, in a development stage of a new product, checking of the yield is performed in order to determine whether various process conditions are appropriate, and development efficiency can be also improved owing to reduction of the time needed for this check.

### SUMMARY OF THE INVENTION

An object of the present invention is to provide an apparatus and a method of semiconductor defect inspection in which an optimal process condition can be determined without performing electric evaluation.

In order to solve the above-mentioned problems, an apparatus and a method of semiconductor defect inspection according to an embodiment of the present invention includes a database storing supplementary information of an already detected defects and a processor identifying the type of an extracted defect with reference to the database that stores the types of defects obtained by inspecting a sample, calculating and braining a defect density according to each defect type for each region of the sample, and thereby displaying the defect density on a display.

Moreover, the apparatus and method of semiconductor defect inspection according to the embodiment of the present invention includes a database storing supplementary information of an already detected defects and a processor identifying the type of the extracted defect with reference to the database that stores the types of defects obtained by inspecting the sample, and calculating, braining and displaying a defect density according to each defect type for each production process of the sample.

The types of defects stored in the database means data sent from a host computer connected with the production process through a network.

According to the present invention, it is possible to provide an apparatus and a method of semiconductor defect inspection in which an optimal process condition can be determined without performing electric evaluation.

### BRIEF DESCRIPTION OF THE DRAWINGS

FIG. 1 is a perspective view of apparatus of semiconductor defect inspection;

FIG. 2 is a system configuration diagram of a group of devices that process image data;

FIG. 3 is a flow chart of an inspection procedure using a VC image;

FIG. 4 is a screen diagram showing an example in which defect density distribution of a VC defect is displayed as an image;

FIG. 5 is a screen diagram showing an example of a screen displayed on a display;

FIG. 6 is a screen diagram showing an example of a screen displayed on a display;

FIG. 7 is a screen diagram showing an example of a screen displayed on a display;

FIG. 8 is a flow chart showing a procedure to obtain an optimal process condition; and

FIG. 9 is a flow chart of in-line QC.

### DETAILED DESCRIPTION OF THE PREFERRED EMBODIMENTS

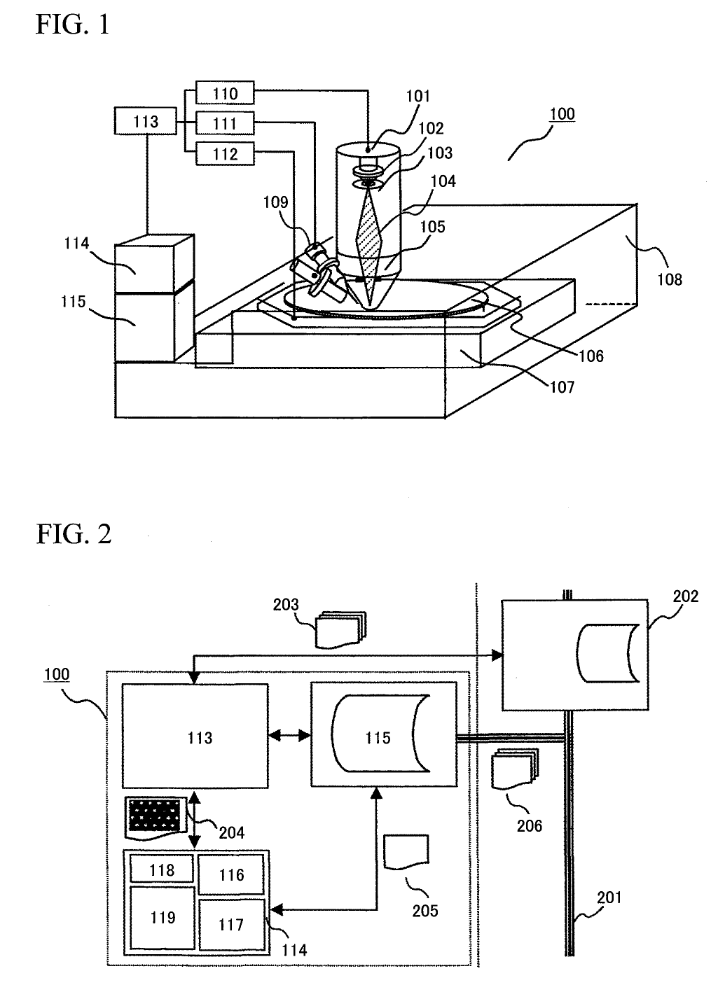

Hereinafter, an embodiment of the present invention will be described using the drawings. FIG. 1 is a perspective view of an apparatus of semiconductor defect inspection. An inspection system 100 of semiconductor defect inspection includes a vacuum column 105 that contains an electron optical system that irradiates a sample 106 with an electron beam 104, a sample chamber 108 that contains a stage 107 on which the sample 106 is placed to be moved, and a control unit 113 that controls the vacuum column 105 and the sample chamber 108. An inside of the vacuum column 105 and an inside of the sample chamber 108 are maintained under vacuum.

The inspection system 100 of semiconductor defect inspection includes an electron source 101 that generates charges enabling defect inspection of a wafer-sized sample, an electromagnetic lens 102 or an electrostatic lens 103 that converges the electron beam 104 generated in the electron source 101, and the vacuum column 105 that maintains these under vacuum. An electron source control unit 110 controls voltage and current for generating and accelerating electrons of the electron source 101. A detector 109 detects a secondary signal obtained by irradiating the sample 106 with the electron beam 104, the sample 106 being a wafer on which semiconductor integrated circuits are formed. An image signal generating unit 111 converts the secondary signal into a digital signal to form an image, and the control unit 113 displays the image of the sample on an unillustrated display. This image is stored through an image analyzing device 114 in a database 115. A stage control unit 112 controls movement of the stage 107. The control unit 113 controls the electron source control unit 110 and the stage control unit 112. Unlike the apparatus of semiconductor defect inspection in the prior art, the database 115 and the image analyzing device 114 are provided in the present embodiment.

FIG. 2 is a system configuration diagram of a group of devices that process image data. The inspection system 100 of semiconductor defect inspection includes the control unit 113, the image analyzing device 114, and the database 115. The control unit 113, the image analyzing device 114, and the database 115 are connected to one another to pass the image data, and are connected to a host computer 202 through a network 201.

A voltage contrast image (VC image) can be obtained with the inspection system 100 of semiconductor defect inspection. Accordingly, contrast of this image is digitized with the image analyzing device 114, and similar defect information is called from the database 115 and referred to. The defect information stored in this database 115 means supplementary information of already detected defects and can be displayed on the display of the image analyzing device 114. Classification of defects is possible by calculating a magnitude and contrast of a defect on the sample 106 with the image analyzing device 114, and comparing with and referring to the data on the defect information stored in the database 115. The image analyzing device 114 includes: a digitizing device 116 that digitizes a coordinate of the defect or the contrast of the image; a defect classification device 117 that classifies the defects; a processor 118 that calculates distribution of the defect and defect density, or the like within the wafer and the chip; and a display 119 that displays the image of the defect, the result of the classification of the detects, and the result of the calculation.

In a semiconductor production line, a basic system is operated, in which multiple manufacturing apparatuses, a lot progress control system, or the like are unified. The manufacturing apparatuses and the apparatus of inspection are connected with the host computer 202 through the network 201 to send or receive the data. In the host computer 202, basic data 203, such as a name of an individual process of a lot and a wafer for the defect inspection, a lot number, a wafer number, a product name, reference process name, a pattern, a layout, and an inspection region, as well as past data of the same kind on the wafer are sent to the inspection system 100 of semiconductor defect inspection through the network 201, and are stored in the database 115. Image data 204, such as a VC luminance map obtained in the inspection system 100 of semiconductor defect inspection, is sent to the image analyzing device 114, and is digitized by the digitizing device 116. For example, the image data 204 is expressed as (x, y, b) where x and y are a position of plane coordinates of the wafer and b is a value obtained by normalizing the contrast. The defect classification device 117 classifies the image data 204 on the basis of a characteristic quantity such as size of the defect and surface properties. The processor 118 digitizes the result of classification. The above-mentioned results can be displayed on the display 119. These pieces of the digitized data 205 are stored in the database 115. Inspection information 206 of the image data 204 or the digitized data 205 is sent to the host computer 202 through the network 201.

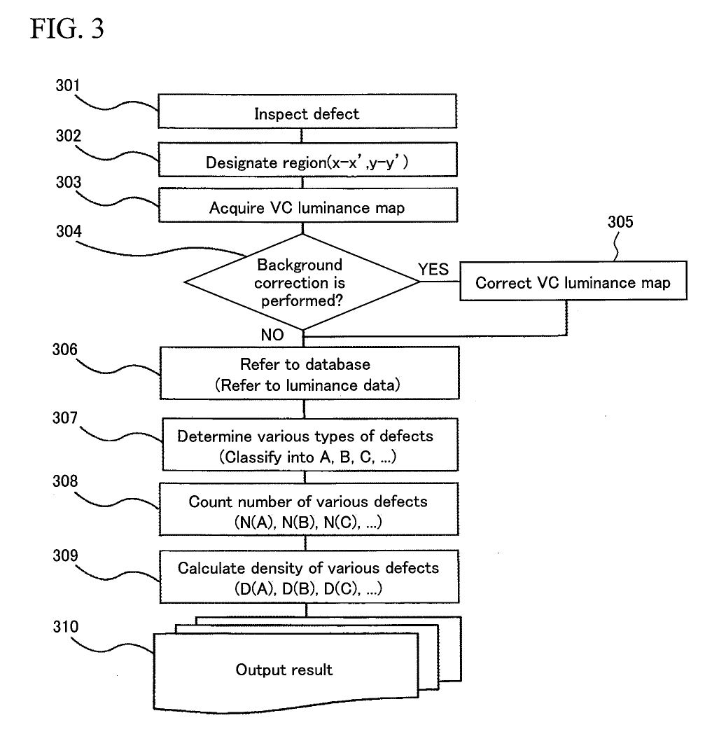

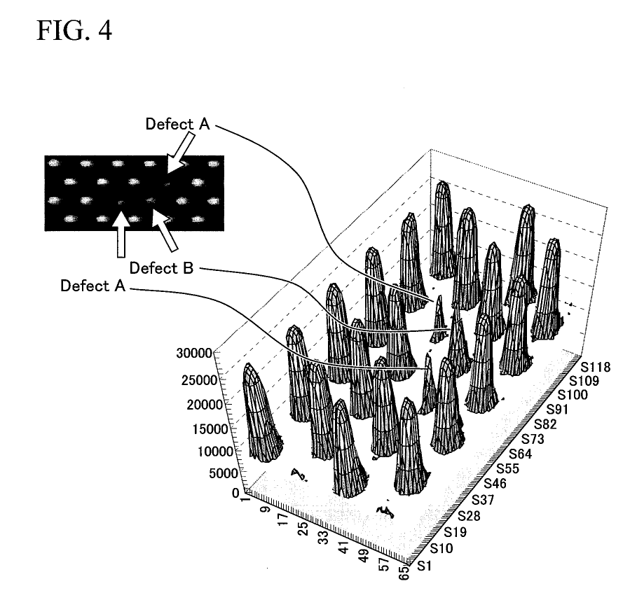

FIG. 3 is a flow chart of an inspection procedure by use of the VC image, and quantification of the defect is performed from the image data. When the defect inspection of the VC image is obtained using the inspection system 100 of semiconductor defect inspection (Step 301), a region of the coordinates (x-x′, y-y′), for example, is designated (Step 302), and a luminance map of the VC image of the defect is acquired (Step 303). Next, a background is corrected when necessary (Step 304). In calculation of the contrast of a defective part, when the contrast of the defective part and a normal part has a small difference, a region of the normal part is arbitrarily selected, the background is corrected, and the VC luminance map is corrected (Step 305). Next, with reference to the luminance data of the database (Step 306), the VC image is digitized and the defect is determined. Here, with reference to the data stored in the database 115 shown in FIG. 2, the defects are classified into the defect types A, B, C and so on . . . by the defect classification device 117 (Step 307). The processor 118 counts the number of each type of the defects like defect numbers N(A), N(B), N(C), and so on . . . (Step 308). The processor 118 calculates a density of each type of the defects like defect densities D(A), D(B), D(C), and so on . . . (Step 309), and displays the density on the display 119 (Step 310). By repeating designation of the region, again, classification of the defects, counting of the number of the defects, and displaying of the density are performed, so that defect density distribution as shown in FIG. 4 is displayed. This result is stored in the database 115 shown in FIG. 2, and simultaneously, is sent to the host computer 202 through the network 201.

FIG. 4 is a screen diagram showing an example in which the defect density distribution of a VC defect is displayed as an image. A three-dimensional graph is generated in which coordinates describing the defect are in the X-axis and Y-axis, and a relative value of the contrast of the image is in the Z-axis. An image shown in the upper left of the graph shows that the image has three VC defects. Thus, distinction of the defects is allowed by digitizing the contrast as shown in the graph and giving a display that is easily recognized. In an example of FIG. 4, two defects A and one defect B are distinguishable. This classification of the defects is executed at Step 307 of the flow chart shown in FIG. 3.

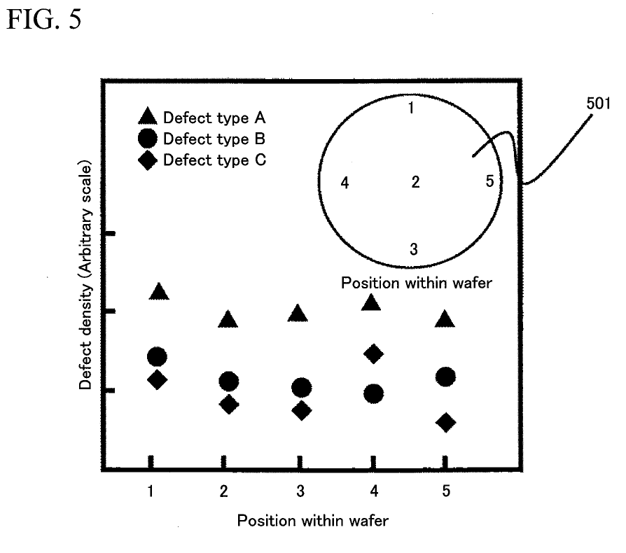

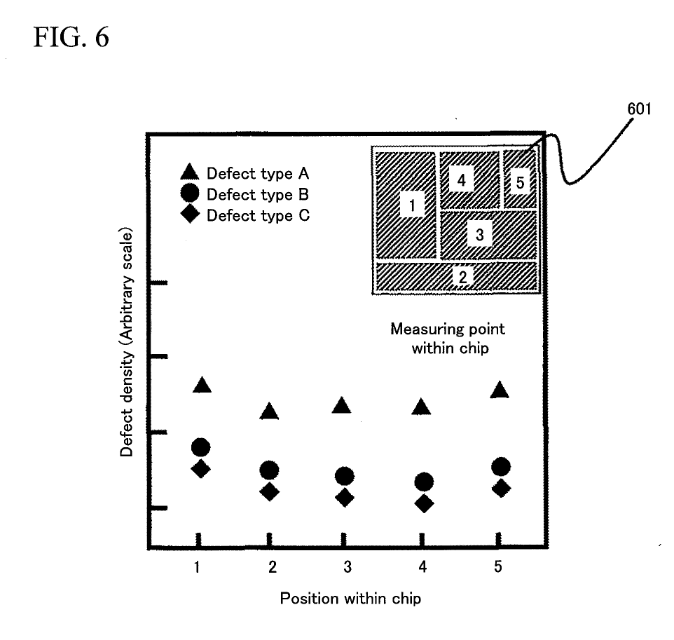

FIG. 5 and FIG. 6 are screen diagrams each showing an example of a screen displayed on the display 119 of FIG. 2, and are an example executed at the result output step of Step 310 of the flow chart shown in FIG. 3. In FIG. 5, a wafer map 501 is displayed on the top right of the screen, and the defect density in each position within the wafer surface indicated by numbers 1 to 5 is shown for each type of the defects. It turns out that the defect density of the defect type A shown by a triangular symbol is larger as a whole, and a large number of the defects of this type occur. In the position of number 4 within the wafer, the defect density of the defect type B and the defect density of the defect type C are reversed, and therefore, it can be assumed that there is a factor responsible for generation of a large number of the defects of the defect type C in the position of number 4. Therefore, the process and cause where the defect of the defective type C is generated may be found out by looking for a relationship between a content of the defective type C and the production process. In FIG. 6, a chip map 601 is displayed on the top right of the screen, and the defect density in each position within a chip indicated by numbers 1 to 5 is shown for each type of the defects. It turns out that the defect density of the defect type A indicated by a triangular symbol is larger as a whole, and a large number of the defects of this type occur. Additionally, in the measuring point of number 1 within the chip, the defect densities of all the defect types are larger, and therefore, it can be assumed that there is a factor responsible for generation of a large number of the defects of all the defect types in the position of number 1.

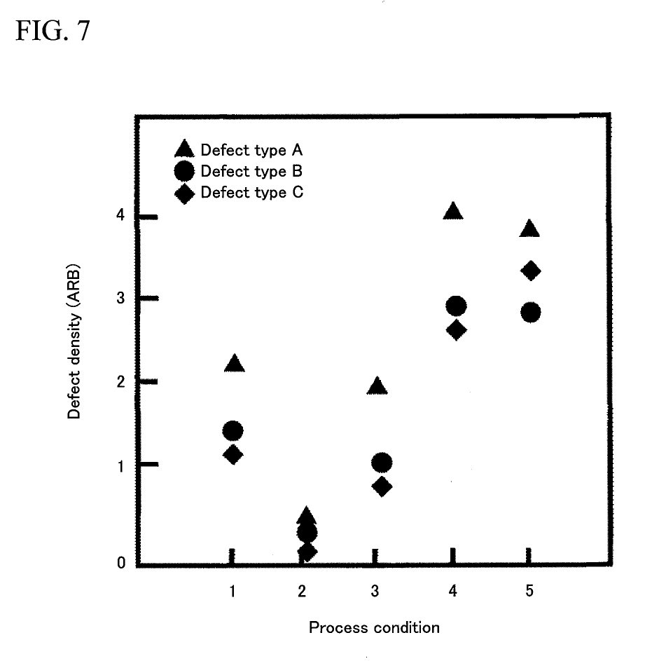

FIG. 7 is a screen diagram showing an example of a screen displayed on the display 119 of FIG. 2, and is an example executed at the result output step of Step 310 of the flow chart shown in FIG. 3. Unlike the cases of FIG. 5 and FIG. 6, an abscissa shows a process condition. Depending on design, it may be necessary to work to find the defect in a part called a hot spot where the defect is easily generated, to observe a cross section by use of an FIB (focused ion beam processing device), and to check a relation of the design and the production process. However, the number of points to be observed is limited in checking finished quality using the SEM, the TEM, or the STEM, and identification of the hot spot is difficult. Accordingly, the yield in the mass production is often obscure. In particular, under the present circumstances, occurrence of an internal defect attributed to shortage of a margin of size in superposition of a three-layered photoresist pattern cannot be easily estimated. However, according to the present invention, since the internal defect can be quantified using the apparatus of semiconductor defect inspection without performing electric evaluation, the apparatus can be used for evaluation of the finished quality under the process condition.

For example, as shown in FIG. 7, with respect to one of the processes such as an etching process and a CVD process, the wafer is processed under 5 different process conditions, and subsequently, the apparatus of semiconductor defect inspection extracts the defect and determines the defect density for each defect type. Since FIG. 7 shows that the fewest defects are generated under the process condition of number 2, this process condition may be selected.

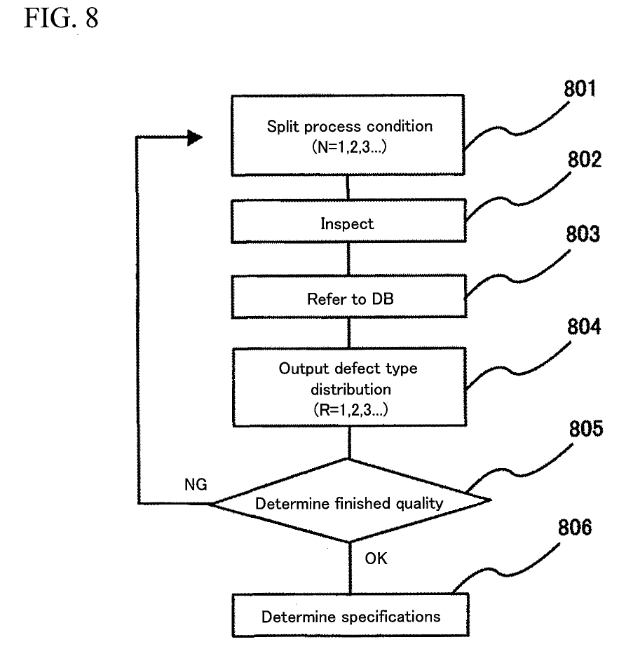

FIG. 8 is a flow chart showing a procedure to obtain an optimal process condition shown in FIG. 7. First, a process to determine the process condition is performed (Step 801), and subsequently, inspection of the defect is performed (Step 802). With respect to the extracted defect, the defect type is identified with reference to the database (Step 803), and distribution of the defect type is obtained (Step 804). The defect density for each process as shown in FIG. 7 is displayed, and determination of the finished quality is performed (Step 805). When the defect density does not satisfy specifications as a result of determination of the finished quality, the steps from Step 801 to step 805 are repeated while the process condition is changed. FIG. 7 shows an example where inspection is performed under 5 process conditions. From the result shown in FIG. 7, when evaluation of the finished quality is satisfactory, the specifications of the process condition are determined (Step 806).

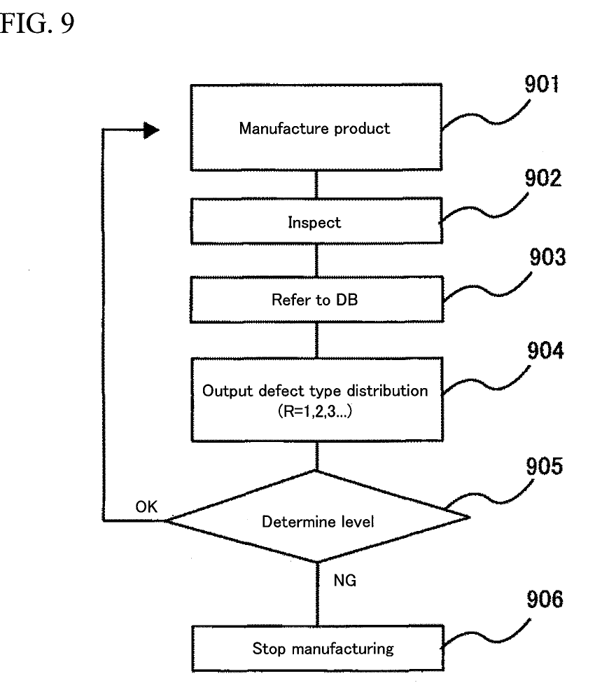

FIG. 9 is a flow chart of in-line QC, which is management of quality of a semiconductor product when manufacturing the semiconductor product in new specifications. In order to prevent generation of the defects attributed to a fluctuation factor of performance of a manufacturing apparatus, apparatus QC for every apparatus is performed by focusing on, for example, foreign substances, thickness of a film, quality of a film, etc. However, it is impossible to detect the defects, not only attributed to one apparatus but also caused in combination of performance fluctuation of several apparatuses, with the apparatus QC for every apparatus. While such a complex defect can be found by electric defect inspection performed in a final process of semiconductor manufacture, it is not easy to find which intermediate process is responsible for the cause. For example, the TAT may be long and reach several weeks, therefore leading to delay of countermeasures against the generated defects when the defects are frequently generated. By applying the present invention to the in-line QC, it is possible to early identify the process where the defects are generated without performing such electric inspection.

First, a product is manufactured under one condition as shown in FIG. 7 (Step 901). Subsequently, the defect is extracted (Step 902), the defect type is identified with reference to the database (Step 903), and distribution is obtained (Step 904). The result as shown in FIG. 7 is obtained, and a level of the defect density for each defect type is determined (Step 905). When the defect density is not less than a predetermined threshold, the steps from Step 901 to Step 905 are repeated while the condition is changed. When the defect density becomes not more than the threshold, it is determined that the condition at the time is optimal, manufacturing is terminated (Step 906), and then, shift to mass production under the condition is performed. Thus, the optimum condition of the process can be determined without performing the electric evaluation.

As mentioned above, according to the present invention, by evaluating the density of the defect generated in the production process of the semiconductor integrated circuit for every coordinate or every process, the optimal process condition can be determined without performing the electric evaluation, and development efficiency of the semiconductor integrated circuit can be improved.

What is claimed is;:

1. A semiconductor defect inspection apparatus that irradiates a sample with an electron beam and detects a defect, comprising:
a database storing supplementary information of an already detected defects;
a defect classification device comparing supplementary information on the defect with the supplementary information of the already detected defects stored in the database, and identifying a type of the defect; and
a processor calculating a defect density according to the type of the defect for each region of the sample, and displaying the defect density on a display.

2. The semiconductor defect inspection apparatus according to claim 1, wherein the supplementary information of the already detected defects stored in the database means the types of the defects, and means data sent from a host computer connected with a production process apparatus of the sample through a network.

3. A semiconductor defect inspection apparatus that irradiates a sample with an electron beam and detects a defect, comprising:
a database storing supplementary information of an already detected defects;
a defect classification device comparing supplementary information of the defect with the supplementary information of the already detected defects stored in the database, and identifying a type of the defect; and
a processor calculating a defect density according to the type of the defect for each production process of the sample, and displaying the defect density on a display.

4. The semiconductor defect inspection apparatus according to claim 3, wherein the supplementary information of the already detected defects stored in the database means the types of the defects, and means data sent from a host computer connected with a production process apparatus of the sample through a network.

5. A method of semiconductor defect inspection, comprising the steps of:
comparing supplementary information of a defect obtained by irradiating a sample with an electron beam, with supplementary information of an already detected defects stored in a database in advance; and
identifying a type of the defect, obtaining a defect density according to the type of the defect for each region of the sample, and displaying the defect density on a display.

6. The method of semiconductor defect inspection according to claim 5, wherein the supplementary information of the already detected defects stored in the database means the types of the defects, and means data sent from a host computer connected with a production process apparatus of the sample through a network.

7. A method of semiconductor defect inspection, comprising the steps of:
comparing supplementary information of a defect obtained by irradiating a sample with an electron beam with supplementary information of an already detected defects stored in a database in advance; and
identifying a type of the defect, obtaining a defect density according to the type of the defect for each production process of the sample, and displaying the defect density on a display.

8. The method of semiconductor defect inspection according to claim 7, wherein the supplementary information of the already detected defects stored in the database means the types of the defects, and means data sent from a host computer connected with a production process apparatus of the sample through a network.
